(19) United States
(12) Patent Application Publication
(10) Pub. No.: US 2018/0299847 A1
(43) Pub. Date: Oct. 18, 2018

(54) LINEAR PARAMETER-VARYING MODEL ESTIMATION SYSTEM, METHOD, AND PROGRAM

(71) Applicant: NEC CORPORATION, Tokyo (JP)

(72) Inventors: Riki ETO, Tokyo (JP); Ryohei FUJIMAKI, Tokyo (JP)

(21) Appl. No.: 15/578,935

(22) PCT Filed: Sep. 25, 2015
(86) PCT No.: PCT/JP2015/004883

§ 371 Date: Dec. 1, 2017

Related U.S. Application Data
(60) Provisional application No. 62/169,796, filed on Jun. 2, 2015.

(51) Int. Cl. G05B 13/04; G06F 17/18

(52) U.S. Cl. CPC G05B 13/048; G06F 17/18; G05B 13/042

(57) ABSTRACT

An initial value determination means 71 determines an initial value of a scheduling parameter of a target system. Furthermore, a convergence determination means 75 determines whether the value of a predetermined evaluation function has converged. Until it is determined that the value of the predetermined evaluation function has converged, a state variable calculation means 72 repeatedly calculates a value of a state variable, a regression coefficient calculation means 73 repeatedly calculates a value of a regression coefficient, and a scheduling parameter prediction model derivation means repeatedly derives a scheduling parameter prediction model and calculates the value of the scheduling parameter. When the value of the predetermined evaluation function converges, a model estimation means 76 estimates a linear parameter-varying model of the target system on the basis of the value of the state variable and the value of the scheduling parameter at that point in time.

### TECHNICAL FIELD

The present invention relates to a linear parameter-varying model estimation system, a linear parameter-varying model estimation method, and a linear parameter-varying model estimation program that estimate a linear parameter-varying model of a physical system.

### BACKGROUND ART

In the following description, a linear parameter-varying model is referred to as linear parameter-varying (LPV) model. The LPV model is a model expressed by a weighted sum of a plurality of models. A plurality of models used to express the LPV model is called local models. FIG. 8 is a schematic diagram of the LPV model expressed by local models. An LPV model 91 is expressed by a weighted sum of local models 92. The weight of each local model 92 is called a scheduling parameter. Each value of the scheduling parameter is 0 or more, and the sum of the values of the scheduling parameters of each local model 92 is 1. That is, the LPV model 91 is a convex combination of the local models 92. Furthermore, as the time elapses, each value of the scheduling parameter can change, but at any time, the sum of the values of the scheduling parameters of each local model 92 is 1. Note that although four local models 92 are illustrated in FIG. 8, the number of the local models 92 is not limited to four.

The LPV model has an advantage that it is possible to express non-linearity and apply an optimization method for linear control.

In recent years, the importance of controlling physical systems has increased due to advancement of information collection boards of physical systems such as internet of things (IoT) and machine to machine (M2M). However, it is difficult for experts to model complex physical systems (in other words, to estimate models of physical systems).

A physical system to be modeled is referred to as target system. In the case of modeling the target system by the LPV model, the target system can be modeled if a value of input data, a value of output data, and a scheduling parameter of the target system are obtained.

PTL 1 describes that a plant is described by an LPV model.

The LPV model is expressed as the following formula (1).

$$\begin{matrix}[ Formula 1 ] & \\ \{ \begin{matrix}{x}_{k + 1} = {\sum }_{i = 1}^{m} {μ}_{k}^{( i )} ( {A}^{( i )} {x}_{k} + {B}^{( i )} {u}_{k} + {K}^{( i )} {e}_{k} ) , \\ {y}_{k} = {Cx}_{k} + {Du}_{k} + {e}_{k}\end{matrix} & ( 1 )\end{matrix}$$

In formula (1), u is a variable expressing input data to the target system, and y is a variable expressing output data from the target system. Furthermore, x is a state variable expressing the state of the target system. e is a variable expressing a prediction error. Furthermore, μ is a scheduling parameter. “k” and “k+1” attached as suffixes to u, y, x, e, and μ expresses time. For example, uₖ is input data at time k. Furthermore, m is the number of local models, and i is a variable expressing the number assigned to the local model. A number from l to m is assigned to the local model and the local model is distinguished by the number. It can be said that a combination of A⁽ⁱ⁾, B⁽ⁱ⁾, and K⁽ⁱ⁾ expresses the i-th local model. Furthermore, μₖ⁽ⁱ⁾ expresses the scheduling parameter at time k in the i-th local model.

### CITATION LIST

### Patent Literature

PTL 1: Japanese Patent Application Laid-Open No. 2012-113676

### SUMMARY OF INVENTION

### Technical Problem

As described above, the LPV model has the advantage that it is possible to express non-linearity and apply an optimization method for linear control. Furthermore, if input data, output data, and a scheduling parameter of the target system are obtained, the target system can be modeled by the LPV model.

However, in many cases, although it is easy to grasp the input data and the output data of the target system, it is difficult to grasp the value of the scheduling parameter. Therefore, since it is not possible to grasp the value of the scheduling parameter, it is often difficult to model the target system by the LPV model.

Furthermore, since the input data and the output data of the target system are data obtained at past time, in the case where the target system is modeled from these data, the model is a model expressing the target system at a point in time in the past.

From the viewpoint of controlling the target model, it is preferable to express the scheduling parameter using an explanatory variable. By expressing the scheduling parameter in this way, it is possible to derive the value of the scheduling parameter from a predicted value of the explanatory variable, and it becomes easier to control the state of the target system in the future.

In view of this, it is an object of the present invention to provide a linear parameter-varying model estimation system, a linear parameter-varying model estimation method, and a linear parameter-varying model estimation program that can estimate an LPV model of a target system and that can express a scheduling parameter using an explanatory variable in the LPV model of the target system even if it is not possible to grasp the value of the scheduling parameter.

Furthermore, it is another object of the present invention to provide a linear parameter-varying model estimation system, a linear parameter-varying model estimation method, and a linear parameter-varying model estimation program that can estimate an LPV model of a target system even if it is not possible to grasp the value of the scheduling parameter.

### Solution to Problem

A linear parameter-varying model estimation system according to the present invention includes an initial value determination means for determining an initial value of a scheduling parameter of a target system to be modeled by a linear parameter-varying model, a state variable calculation means for calculating a value of a state variable on the basis of a value of input data, a value of output data, and a value of a scheduling parameter of the target system, a regression coefficient calculation means for calculating a value of a regression coefficient when a value of a predetermined evaluation function becomes a minimum, with the value of the scheduling parameter and the value of the state variable as fixed values, a scheduling parameter prediction model derivation means for calculating the value of the scheduling parameter when the value of the predetermined evaluation function becomes a minimum, with the value of the state variable and the value of the regression coefficient as fixed values, deriving a scheduling parameter prediction model that is a function of the scheduling parameter using an explanatory variable on the basis of the value of the scheduling parameter and a previously given value of the explanatory variable, and calculating the value of the scheduling parameter on the basis of the scheduling parameter prediction model, and a convergence determination means for determining whether the value of the evaluation function has converged. With respect to the state variable calculation means, the regression coefficient calculation means, and the scheduling parameter prediction model derivation means, until it is determined that the value of the evaluation function has converged, the state variable calculation means repeatedly calculates the value of the state variable, the regression coefficient calculation means repeatedly calculates the value of the regression coefficient, and the scheduling parameter prediction model derivation means repeatedly derives the scheduling parameter prediction model and calculates the value of the scheduling parameter on the basis of the scheduling parameter prediction model. The linear parameter-varying model estimation system further includes a model estimation means for estimating the linear parameter-varying model of the target system on the basis of the value of the state variable and the value of the scheduling parameter at a point in time when it is determined that the value of the evaluation function has converged. The model estimation means expresses the scheduling parameter by the scheduling parameter prediction model in the linear parameter-varying model.

Furthermore, a linear parameter-varying model estimation system according to the present invention includes an initial value determination means for determining an initial value of a scheduling parameter of a target system to be modeled by a linear parameter-varying model, a state variable calculation means for calculating a value of a state variable on the basis of a value of input data, a value of output data, and a value of a scheduling parameter of the target system, a regression coefficient calculation means for calculating a value of a regression coefficient when a value of a predetermined evaluation function becomes a minimum, with the value of the scheduling parameter and the value of the state variable as fixed values, a scheduling parameter calculation means for calculating the value of the scheduling parameter when the value of the predetermined evaluation function becomes a minimum, with the value of the state variable and the value of the regression coefficient as fixed values, and a convergence determination means for determining whether the value of the evaluation function has converged. With respect to the state variable calculation means, the regression coefficient calculation means, and the scheduling parameter calculation means, until it is determined that the value of the evaluation function has converged, the state variable calculation means repeatedly calculates the value of the state variable, the regression coefficient calculation means repeatedly calculates the value of the regression coefficient, and the scheduling parameter calculation means repeatedly calculates the value of the scheduling parameter. The linear parameter-varying model estimation system further includes a model estimation means for estimating the linear parameter-varying model of the target system on the basis of the value of the state variable and the value of the scheduling parameter at a point in time when it is determined that the value of the evaluation function has converged.

Furthermore, a linear parameter-varying model estimation method according to the present invention includes: determining an initial value of a scheduling parameter of a target system to be modeled by a linear parameter-varying model, calculating a value of a state variable on the basis of a value of input data, a value of output data, and a value of a scheduling parameter of the target system, calculating a value of a regression coefficient when a value of a predetermined evaluation function becomes a minimum, with the value of the scheduling parameter and the value of the state variable as fixed values, calculating a value of the scheduling parameter when the value of the predetermined evaluation function becomes a minimum, with the value of the state variable and the value of the regression coefficient as fixed values, deriving a scheduling parameter prediction model that is a function of the scheduling parameter using an explanatory variable on the basis of the value of the scheduling parameter and a previously given value of the explanatory variable, and calculating the value of the scheduling parameter on the basis of the scheduling parameter prediction model, determining whether the value of the valuation function has converged, until it is determined that the value of the evaluation function has converged, repeatedly calculating the value of the state variable, calculating the value of the regression coefficient, and deriving the scheduling parameter prediction model, and calculating the value of the scheduling parameter on the basis of the scheduling parameter prediction model, estimating the linear parameter-varying model of the target system on the basis of the value of the state variable and the value of the scheduling parameter at a point in time when it is determined that the value of the evaluation function has converged, and expressing the scheduling parameter by the scheduling parameter prediction model in the linear parameter-varying model.

Furthermore, a linear parameter-varying model estimation method according to the present invention includes: determining an initial value of a scheduling parameter of a target system to be modeled by a linear parameter-varying model, calculating a value of a state variable on the basis of a value of input data, a value of output data, and a value of a scheduling parameter of the target system, calculating a value of a regression coefficient when a value of a predetermined evaluation function becomes a minimum, with the value of the scheduling parameter and the value of the state variable as fixed values, calculating a value of the scheduling parameter when the value of the predetermined evaluation function becomes a minimum, with the value of the state variable and the value of the regression coefficient as fixed values, determining whether the value of the evaluation function has converged, until it is determined that the value of the evaluation function has converged, repeatedly calculating the value of the state variable, calculating the value of the regression coefficient, and calculating the value of the scheduling parameter, and estimating the linear parameter-varying model of the target system on the basis of the value of the state variable and the value of the scheduling parameter at a point in time when it is determined that the value of the evaluation function has converged.

Furthermore, a linear parameter-varying model estimation program according to the present invention causes a computer to perform an initial value determination process of determining an initial value of a scheduling parameter of a target system to be modeled by a linear parameter-varying model, a state variable calculation process of calculating a value of a state variable on the basis of a value of input data, a value of output data, and a value of the scheduling parameter of the target system, a regression coefficient calculation process of calculating a value of a regression coefficient when a value of a predetermined evaluation function becomes a minimum, with the value of the scheduling parameter and the value of the state variable as fixed values, a scheduling parameter prediction model derivation process of calculating a value of the scheduling parameter when the value of the predetermined evaluation function becomes a minimum, with the value of the state variable and the value of the regression coefficient as fixed values, deriving a scheduling parameter prediction model that is a function of the scheduling parameter using an explanatory variable on the basis of the value of the scheduling parameter and a previously given value of the explanatory variable, and calculating the value of the scheduling parameter on the basis of the scheduling parameter prediction model, a convergence determination process of determining whether the value of the evaluation function has converged, until it is determined that the value of the evaluation function has converged, repeatedly the state variable calculation process, the regression coefficient calculation process, and scheduling parameter prediction model derivation process, a model estimation process of estimating the linear parameter-varying model of the target system on the basis of the value of the state variable and the value of the scheduling parameter at a point in time when it is determined that the value of the evaluation function has converged, and expressing the scheduling parameter by the scheduling parameter prediction model in the linear parameter-varying model in the model estimation process.

Furthermore, a linear parameter-varying model estimation program according to the present invention causes a computer to perform an initial value determination process of determining an initial value of a scheduling parameter of a target system to be modeled by a linear parameter-varying model, a state variable calculation process of calculating a value of a state variable on the basis of a value of input data, a value of output data, and a value of the scheduling parameter of the target system, a regression coefficient calculation process of calculating a value of a regression coefficient when a value of a predetermined evaluation function becomes a minimum, with the value of the scheduling parameter and the value of the state variable as fixed values, a scheduling parameter calculation process of calculating a value of the scheduling parameter when the value of the predetermined evaluation function becomes a minimum, with the value of the state variable and the value of the regression coefficient as fixed values, a convergence determination process of determining whether the value of the evaluation function has converged, until it is determined that the value of the evaluation function has converged, repeatedly the state variable calculation process, the regression coefficient calculation process, and the scheduling parameter calculation process, and a model estimation process of estimating the linear parameter-varying model of the target system on the basis of the value of the state variable and the value of the scheduling parameter at a point in time when it is determined that the value of the evaluation function has converged.

### Advantageous Effects of Invention

According to the present invention, it is possible to estimate the LPV model of the target system even if it is not possible to grasp the value of the scheduling parameter, and to express the scheduling parameter using the explanatory variable in the LPV model of the target system.

Furthermore, according to the present invention, it is possible to estimate the LPV model of the target system, even if it is not possible to grasp the value of the scheduling parameter.

### BRIEF DESCRIPTION OF DRAWINGS

FIG. 1 It depicts a block diagram illustrating an exemplary configuration of an LPV model estimation system according to a first exemplary embodiment of the present invention.

FIG. 2 It depicts a flowchart illustrating an exemplary process progress according to the first exemplary embodiment.

FIG. 3 It depicts a block diagram illustrating an exemplary configuration of an LPV model estimation system according to a second exemplary embodiment of the present invention.

FIG. 4 It depicts a flowchart illustrating an exemplary process progress according to the second exemplary embodiment.

FIG. 5 It depicts a schematic block diagram illustrating an exemplary configuration of a computer according to each exemplary embodiment of the present invention.

FIG. 6 It depicts a block diagram illustrating an overview of the LPV model estimation system according to the present invention.

FIG. 7 It depicts a block diagram illustrating an overview of an LPV model estimation system according to another mode of the present invention.

FIG. 8 It depicts a schematic diagram of an LPV model expressed by a local model.

### DESCRIPTION OF EMBODIMENTS

Hereinafter, exemplary embodiments of the present invention will be described with reference to the drawings.

### First Exemplary Embodiment

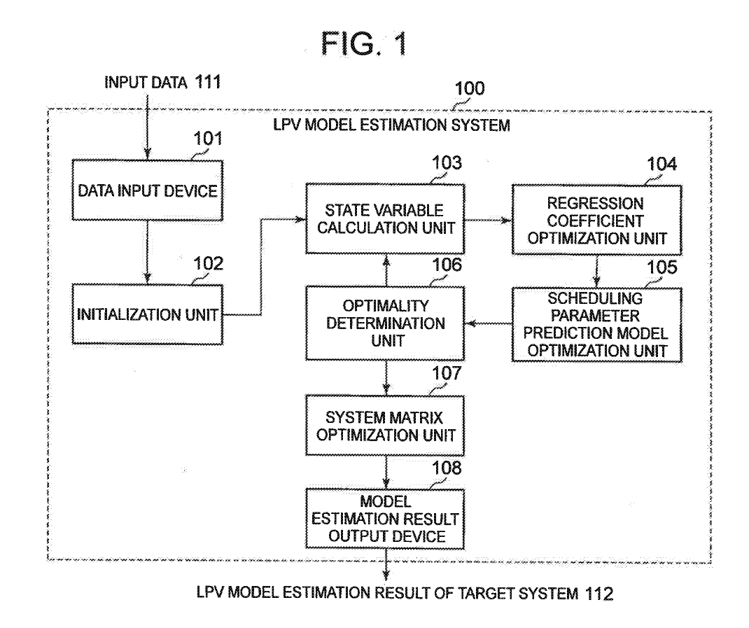

FIG. 1 is a block diagram illustrating an exemplary configuration of a linear parameter-varying model estimation system (hereinafter referred to as LPV model estimation system) according to a first exemplary embodiment of the present invention. The LPV model estimation system 100 according to the present invention includes a data input device 101, an initialization unit 102, a state variable calculation unit 103, a regression coefficient optimization unit 104, a scheduling parameter prediction model optimization unit 105, an optimality determination unit 106, a system matrix optimization unit 107, and a model estimation result output device 108.

The data input device 101 is an input device for obtaining input data 111. The input data 111 is data necessary for the LPV model estimation system 100 to estimate a LPV model of a target system (physical system to be modeled). The data input device 101 is, for example, a data reading device that reads the input data 111 recorded on a data recording medium such as an optical disk. However, the data input device 101 is not limited to such a data reading device. Furthermore, the data input device 101 may be an input device for a user to input the input data 111.

The input data 111 includes input data input to the target system (not illustrated) in the past and output data output from the target system in the past. Note that the input data input to the LPV model estimation system 100 according to the present invention is denoted by reference sign 111, and the input data input to the target system in the past is denoted by no reference sign, thereby distinguishing between both the input data. In the following description, time is expressed by k. The input data 111 includes values of input data to the target system and values of output data from the target system at past time k=1, 2, . . . , and N. That is, the input data 111 includes values of input data and values of output data at past N times. Note that the times in chronological order are expressed as 1, 2, . . . , and N. As illustrated in formula (1), input data at time k is written as uₖ, and output data at time k is written as yₖ.

Furthermore, the input data 111 also includes the number of local models. Hereinafter, the number of local models is assumed to be m.

Furthermore, the input data 111 includes the value of a window parameter in a subspace identification method. Hereinafter, the value of this window parameter is p. In the subspace identification method, a group of data (time series data) arranged consecutively in chronological order is handled as sample data. Hereinafter, this sample data will be referred to as time series sample. The value p of the window parameter in the subspace identification method is the predetermined number described above. One time series sample is a vector in which p pieces of data are arranged in chronological order. In addition, it is assumed to be p<N. Furthermore, a time series sample in which p pieces of data are arranged in order with the data at time k as the first data is called a time series sample at time k. It can be said that the time series sample expresses temporal changes of the data. When N pieces of data are given, N−p+1 time series samples are obtained from the N pieces of data. The subspace identification method deals with the mapping relation of time series samples.

The input data 111 also includes information illustrating the form of a scheduling parameter prediction model determined for each of m local models. Herein, the scheduling parameter prediction model is a function that expresses a scheduling parameter using an explanatory variable. For example, in the case where the scheduling parameters of the first and second local models are μ⁽¹⁾ and μ⁽²⁾, respectively, information illustrating that the scheduling parameters of these local models are expressed in a form of μ⁽¹⁾=a×φ+b, μ⁽²⁾=c×φ²+d×φ, or the like is included in the input data 111. In the above example, φ is an explanatory variable, a, c, and d are coefficients, and b is a constant term. This information only expresses the form of the function, and does not determine the values of the coefficients such as a, c, d, and the like exemplified above and the value of the constant term b. In the above example, the form of the functions of the two local models is illustrated, but the form of the function is determined for each of the m local models. Furthermore, the forms of the above two functions are examples, and the forms of the functions are not limited to the above examples. Each of these functions (scheduling parameter prediction model) is derived as a regression model as described later.

Furthermore, the input data 111 also includes the value of the explanatory variable (p at the past time.

The data input device 101 simultaneously obtains the various data included in the input data 111.

Note that in each exemplary embodiment of the present invention, it is assumed that the value of the scheduling parameter of each local model can vary with the lapse of time. Furthermore, the explanatory variable at time k is expressed as φₖ. Furthermore, the scheduling parameter at time k in the i-th local model is expressed as μₖ⁽ⁱ⁾. In addition, the scheduling parameter prediction model at time k in the i-th local model is expressed as the following formula (2).

[Formula 2]

μₖ⁽ⁱ⁾=gᵢ(ϕₖ) (2)

In the present exemplary embodiment, the LPV model is expressed as the following formula (3).

$$\begin{matrix}[ Formula 3 ] & \\ \{ \begin{matrix}{x}_{k + 1} = {\sum }_{i = 1}^{m} {g}_{i} ( {φ}_{k} ) ( {A}^{( i )} {x}_{k} + {B}^{( i )} {u}_{k} + {K}^{( i )} {e}_{k} ) , \\ {y}_{k} = {Cx}_{k} + {Du}_{k} + {e}_{k}\end{matrix} & ( 3 )\end{matrix}$$

Formula (3) expresses a scheduling parameter μₖ⁽ⁱ⁾ in the above-described formula (1) using the scheduling parameter prediction model gᵢ(φₖ), and the meaning of each of other variables in formula (3) is similar to the meaning of each variable in formula (1).

The initialization unit 102 determines an initial value of the scheduling parameter ρₖ⁽ⁱ⁾ of each local model at each past time k=p, p+1, . . . , and N. The initialization unit 102 determines an initial value of the scheduling parameter for each combination of i and k. As already described, each value of the scheduling parameter is 0 or more. Furthermore, the sum of the values of the scheduling parameters of each local model at any time is 1. Therefore, as long as the condition that each initial value of the scheduling parameter is 0 or more and the sum of the initial values of the scheduling parameters of the m local models at the same time is 1 is satisfied, the initialization unit 102 may determine the initial value of the scheduling parameter of each local model at each time by any method.

The state variable calculation unit 103 calculates a value of a state variable xₖ at the past time on the basis of the value of the input data to the target system in the past, the value of the output data from the target system, and the value of the scheduling parameter of each local model.

When calculating the value of the state variable xₖ, the state variable calculation unit 103 executes the subspace identification method for the LPV model. At this time, the state variable calculation unit 103 obtains an augmented observability matrix by using input data and output data at time k=1, 2, . . . , and N, the number of local models, and the window parameter, and calculates the value of the state variable xₖ on the basis of the augmented observability matrix. More specifically, the state variable calculation unit 103 creates a time series sample. On the basis of an assumption that the target system is stable, the state variable calculation unit 103 approximates a correspondence relationship between the time series sample at time k and a time series sample at time k+p by a linear regression model. At this time, the state variable calculation unit 103 uses the number of local models m. The state variable calculation unit 103 obtains a regression coefficient in the linear regression model by the least squares method. By using the regression coefficient, the state variable calculation unit 103 obtains a product of the augmented observability matrix and the augmented reachability matrix, and applies a singular value decomposition to the product, thereby calculating the value of the state variable xₖ at the past time.

Note that the first data at time of k=1, . . . , and p−1 among the N times cannot constitute a time series sample. Therefore, the state variable calculation unit 103 obtains the state variable xₖ at each time of k=p, p+1, . . . , and N obtained by excluding the time of k=1, . . . , and p−1 from the N times.

Furthermore, as described later, the scheduling parameter prediction model optimization unit 105 derives the scheduling parameter prediction model and calculates the value of the scheduling parameter of each local model on the basis of the scheduling parameter prediction model. When calculating the value of the state variable xₖ first time, the state variable calculation unit 103 uses the initial value of the scheduling parameter determined by the initialization unit 102. In the second and subsequent processes for calculating the value of the state variable xₖ, the state variable calculation unit 103 uses the value of the scheduling parameter calculated by the scheduling parameter prediction model optimization unit 105 on the basis of the scheduling parameter prediction model.

The regression coefficient optimization unit 104 optimizes a regression coefficient W⁽ⁱ⁾ in the LPV model using the calculated value of the scheduling parameter and the calculated value of the state variable. The regression coefficient W⁽ⁱ⁾ in the LPV model is a combination of A⁽ⁱ⁾, B⁽ⁱ⁾ and C in formula (3). Specifically, W⁽ⁱ⁾ is a coefficient calculated as W⁽ⁱ⁾: =[CA⁽ⁱ⁾, CB⁽ⁱ⁾]. As will be described later, A⁽ⁱ⁾, B⁽ⁱ⁾, K⁽ⁱ⁾, C, and D (refer to formula (3)) is called a system matrix. Therefore, it can be said that the regression coefficient W⁽ⁱ⁾ is a coefficient expressed by a predetermined system matrices A⁽ⁱ⁾, B⁽ⁱ⁾, and C in the system matrix. Note that the regression coefficient optimization unit 104 assumes that D in formula (3) is a zero matrix. Furthermore, since K⁽ⁱ⁾ in formula (3) relates to a regression error, it is not a constituent element of the regression coefficient W⁽ⁱ⁾.

The regression coefficient optimization unit 104 calculates the value of the regression coefficient W⁽ⁱ⁾ when the value of the evaluation function of LPV system identification becomes a minimum, with the calculated value of the scheduling parameter and the calculated value of the state variable as fixed values. This value is the optimum value of the regression coefficient W⁽ⁱ⁾.

The above evaluation function is expressed as the following formula (4).

$$\begin{matrix}[ Formula 4 ] & \\ {\sum }_{k = 0}^{N - 1} {‖ {y}_{k + 1} - {\sum }_{i = 1}^{m} {μ}_{k}^{( i )} {W}^{( i )} [ \begin{matrix}{x}_{k} \\ {u}_{k}\end{matrix} ] ‖}^{2} & ( 4 )\end{matrix}$$

That is, the regression coefficient optimization unit 104 calculates the following formula (5) with the calculated value of the scheduling parameter and the calculated value of the state variable as fixed values.

$$\begin{matrix}[ Formula 5 ] & \\ {μ}^{N *} , {x}^{N *} , {W}^{*} = {argmin}_{{μ}^{N} , {x}^{N} , W} {\sum }_{k = 0}^{N - 1} {‖ {y}_{k + 1} - {\sum }_{i = 1}^{m} {μ}_{k}^{( i )} {W}^{( i )} [ \begin{matrix}{x}_{k} \\ {u}_{k}\end{matrix} ] ‖}^{2} & ( 5 )\end{matrix}$$

By setting the value of the calculated scheduling parameter and the calculated value of the state variable to fixed values, an objective function can be transformed as the following formula (6).

$$\begin{matrix}[ Formula 6 ] & \\ {argmin}_{W} {\sum }_{k = p + 1}^{N} {‖ {y}_{k + 1} - {W}_{{μ}_{k}} ⊗ [ \begin{matrix}{x}_{k} \\ {u}_{k}\end{matrix} ] ‖}^{2} & ( 6 )\end{matrix}$$

W illustrated in formula (6) means W⁽¹⁾, W⁽²⁾, . . . , and W^{(m)}. The regression coefficient optimization unit 104 calculates W by the least squares method, with W as a regression coefficient and with ones other than W as explanatory variables in the second term in the norm illustrated in formula (6) after formula deformation.

The scheduling parameter prediction model optimization unit 105 optimizes the scheduling parameter prediction model of each local model using the value of the calculated state variable and the calculated value of the regression coefficient W⁽ⁱ⁾.

The scheduling parameter prediction model optimization unit 105 calculates the value of the scheduling parameter when the value of the evaluation function of the LPV system identification (refer to formula (4)) becomes a minimum, with the calculated value of the state variable and the calculated value of the regression coefficient W⁽ⁱ⁾ as fixed values. However, the scheduling parameter prediction model optimization unit 105 obtains the value of the scheduling parameter μₖ⁽ⁱ⁾ of each local model at each time k=p, p+1, . . . , and N.

In the case where the calculated value of the state variable and the calculated value of the regression coefficient W⁽ⁱ⁾ are fixed values, formula (5) can be transformed as the following formula (7).

$$\begin{matrix}[ Formula 7 ] & \\ {μ}_{k}^{*} = {argmin}_{{μ}_{k}} \{ \frac{1}{2} {μ}_{k}^{T} ( 2 {Λ}_{k}^{T} {Λ}_{k} ) {μ}_{k} - 2 {y}_{k + 1}^{T} {Λ}_{k} {μ}_{k} \} & ( 7 )\end{matrix}$$

Note that T means a transposed matrix.

Note that it is assumed that the following formula (8) is satisfied.

[Formula 8]

1ₘ^{T}μₖ=1, −μₖ [symbol] 0ₘ (8)

Furthermore, λₖ⁽ⁱ⁾, Λₖ, 1ₘ, and 0ₘ are expressed by the following formulas.

$$[ Formula 9 ]$$

$${λ}_{k}^{( i )} := {W}^{( i )} [ \begin{matrix}{x}_{k} \\ {u}_{k}\end{matrix} ] \\ [ Formula 10 ]$$

$${Λ}_{k} := [ {λ}_{k}^{( 1 )} , … , {λ}_{k}^{( m )} ] \\ [ Formula 11 ]$$

$${1}_{m} := {[ 1 , … , 1 ]}^{T} ∈ {ℝ}^{m} \\ [ Formula 12 ]$$

$${0}_{m} := {[ 0 , … , 0 ]}^{T} ∈ {ℝ}^{m}$$

Furthermore,

[symbol]

[Formula 13]

means an m-dimensional vector.

The scheduling parameter prediction model optimization unit 105 calculates the value of the scheduling parameter when the value of the evaluation function illustrated in formula (4) becomes a minimum by solving the quadratic programming problem in formula (7). This value is the optimum value of the scheduling parameter. As a result, the value of the scheduling parameter for each local model is obtained.

The scheduling parameter prediction model optimization unit 105 derives the scheduling parameter prediction model for each local model on the basis of the value of the scheduling parameter calculated as described above, the format of the scheduling parameter prediction model determined for each local model, and the explanatory variable cp. The scheduling parameter prediction model optimization unit 105 derives the scheduling parameter prediction model by machine learning. This machine learning is mainly supervised learning. As the machine learning, for example, kernel linear regression or support vector machine may be adopted.

Furthermore, the scheduling parameter prediction model optimization unit 105 calculates the value of the scheduling parameter on the basis of the derived scheduling parameter prediction model. The scheduling parameter prediction model optimization unit 105 calculates the value of the scheduling parameter by substituting the value of the explanatory variable φ into the derived scheduling parameter prediction model.

The scheduling parameter needs to satisfy a condition for corresponding to a convex combination coefficient. That is, it is necessary to satisfy the condition that each value of the scheduling parameter is 0 or more and the sum of the values of the scheduling parameters of m local models at the same time is 1. In order for the scheduling parameter prediction model optimization unit 105 to satisfy such a condition, the scheduling parameter prediction model optimization unit 105 adjusts the value of the scheduling parameter by performing the following process.

The scheduling parameter prediction model optimization unit 105 adjusts the value of the scheduling parameter by solving the quadratic programming problem in the following formula (9).

$$\begin{matrix}[ Formula 9 ] & \\ {\hat{μ}}_{k}^{*} = {argmin}_{\hat{μ}} {‖ {\hat{μ}}_{k} - {\tilde{μ}}_{k} ‖}^{2} = {argmin}_{\hat{μ}} ( {\hat{μ}}_{k}^{T} {\hat{μ}}_{k} - 2 {\tilde{μ}}_{k}^{T} {\hat{μ}}_{k} ) & ( 9 )\end{matrix}$$

Note that it is assumed that the following formula (10) is satisfied.

[Formula 15]

1ₘ^{T}\tilde{μ}ₖ=1, −\tilde{μ}ₖ [symbol] 0ₘ (10)

Herein, μ with a tilde is expressed by the following formula.

\tilde{μ}ₖ:=W_{g}*ϕₖ [Formula 16]

Furthermore, μ with a caret is the scheduling parameter calculated on the basis of the scheduling parameter prediction model.

The optimality determination unit 106 determines whether the value of the evaluation function illustrated in formula (4) has converged.

The state variable calculation unit 103, the regression coefficient optimization unit 104, and the scheduling parameter prediction model optimization unit 105 sequentially repeat the above-described processes until it is determined that the values of the evaluation function have converged.

In the case where it is determined that the value of the evaluation function has converged, the system matrix optimization unit 107 performs a regression calculation using the value of the state variable (optimum value of the state variable) obtained at that point in time and the value of the scheduling parameter calculated on the basis of the scheduling parameter prediction model, thereby optimizing each system matrix of the LPV model. Herein, each system matrix means A⁽ⁱ⁾, B⁽ⁱ⁾, K⁽ⁱ⁾, C, and D (refer to formula (3)) in each local model. That is, A⁽ⁱ⁾, B⁽ⁱ⁾, K⁽ⁱ⁾, C, and D each correspond to each system matrix.

The system matrix optimization unit 107 calculates each system matrix A⁽ⁱ⁾, B⁽ⁱ⁾, K⁽ⁱ⁾, C, and D by the least squares method using yₖ, uₖ, and xₖ at each time. Each resultant system matrix is an optimized system matrix.

The system matrix optimization unit 107 determines the LPV model expressed by the calculated system matrices A⁽ⁱ⁾, B⁽ⁱ⁾, K⁽ⁱ⁾, C, and D and the scheduling parameter prediction model gᵢ(φₖ) obtained at a point in time when it is determined that the values of the evaluation function has converged. This LPV model is an estimation result of the LPV model of the target system. That is, it can be said that the system matrix optimization unit 107 estimates the LPV model of the target system. Furthermore, it can be said that the system matrix optimization unit 107 expresses the scheduling parameter by the scheduling parameter prediction model gᵢ(φₖ) in the LPV model.

The model estimation result output device 108 is an output device that outputs the LPV model (an LPV model estimation result of the target system 112) determined by the system matrix optimization unit 107. A mode in which the model estimation result output device 108 outputs the LPV model is not particularly limited. For example, the model estimation result output device 108 may display and output the LPV model. Furthermore, for example, the model estimation result output device 108 may transmit the LPV model to an external system (not illustrated).

The initialization unit 102, the state variable calculation unit 103, the regression coefficient optimization unit 104, the scheduling parameter prediction model optimization unit 105, the optimality determination unit 106, and the system matrix optimization unit 107 are achieved by, for example, a central processing unit (CPU) in a computer that operates according to the linear parameter-varying model estimation program. In this case, the CPU reads a linear parameter-varying model estimation program from a program recording medium such as a program storage device (not illustrated in FIG. 1) of the computer, for example, and may operate as the initialization unit 102, the state variable calculation unit 103, the regression coefficient optimization unit 104, the scheduling parameter prediction model optimization unit 105, the optimality determination unit 106, and the system matrix optimization unit 107 according to the linear parameter-varying model estimation program. Furthermore, the initialization unit 102, the state variable calculation unit 103, the regression coefficient optimization unit 104, the scheduling parameter prediction model optimization unit 105, the optimality determination unit 106, and the system matrix optimization unit 107 may be achieved by separate hardware.

Furthermore, the LPV model estimation system 100 may be configured such that two or more physically separated devices are connected by wires or wirelessly. This point is similarly applied to another exemplary embodiment described later.

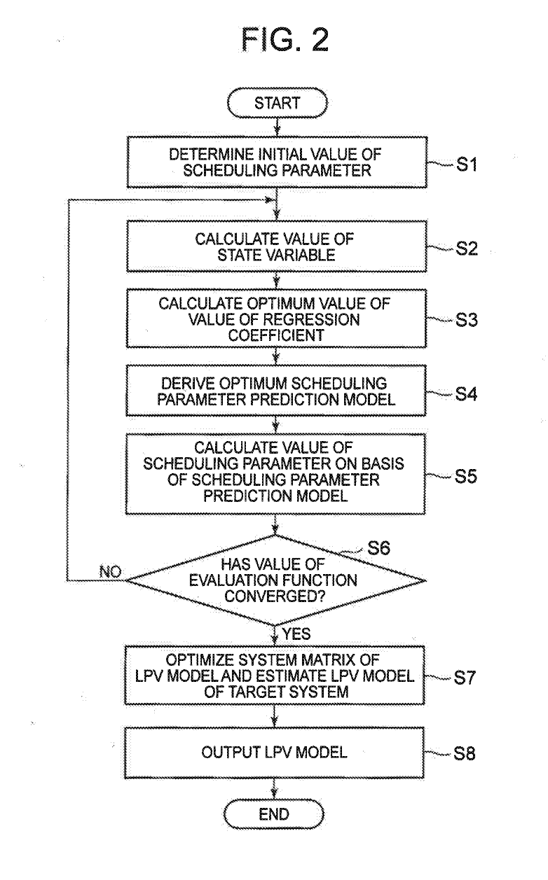

Next, a process progress according to the first exemplary embodiment will be described. FIG. 2 is a flowchart illustrating an exemplary process progress according to the first exemplary embodiment. Since details of the operation of the constituent elements of the LPV model estimation system 100 have already been described, detailed description of the operation will be omitted in the following description. Furthermore, it is assumed that the data input device 101 has obtained input data 111.

The initialization unit 102 determines the initial value of the scheduling parameter μₖ⁽ⁱ⁾ of each local model (step S1). The number of local models m is included in the input data 111. In step S1, the initialization unit 102 determines the initial value of the scheduling parameter μₖ⁽ⁱ⁾ of each local model so as to satisfy the condition that each initial value of the scheduling parameter is 0 or more and the sum of the initial values of the scheduling parameters of m local models at the same time is 1. As long as the above-described conditions are satisfied, the initialization unit 102 may sequentially determine the initial value of the scheduling parameter μₖ⁽ⁱ⁾ at random.

Next, the state variable calculation unit 103 calculates the value of the state variable xₖ at the past time on the basis of the value of the input data to the target system in the past, the value of the output data from the target system, and the value of the scheduling parameter of each local model in the past (step S2). When the process shifts to step S2 first, the state variable calculation unit 103 uses the initial value of the scheduling parameter determined in step S1.

Next, the regression coefficient optimization unit 104 calculates the optimum value of the regression coefficient W⁽ⁱ⁾ in the LPV model using the calculated value of the scheduling parameter and the calculated value of the state variable (step S3). When the process shifts to step S3 first, the regression coefficient optimization unit 104 uses the initial value of the scheduling parameter determined in step S1. In step S3, the regression coefficient optimization unit 104 calculates the value of the regression coefficient W⁽ⁱ⁾ when the value of the evaluation function illustrated in formula (4) becomes a minimum, with the calculated value of the scheduling parameter and the calculated value of the state variable as fixed values.

Next, the scheduling parameter prediction model optimization unit 105 derives the optimum scheduling parameter prediction model of each local model by using the value of the calculated state variable and the value of the regression coefficient W⁽ⁱ⁾ (step S4). In step S4, the scheduling parameter prediction model optimization unit 105 calculates the value of the scheduling parameter when the value of the evaluation function illustrated in formula (4) becomes a minimum, with the calculated value of the state variable and the calculated value of the regression coefficient W⁽ⁱ⁾ being fixed values. Furthermore, the scheduling parameter prediction model optimization unit 105 derives the scheduling parameter prediction model of each local model by machine learning on the basis of the value of the scheduling parameter, the format of the scheduling parameter prediction model determined for each local model, and the value of the explanatory variable φ.

Next, the scheduling parameter prediction model optimization unit 105 calculates the value of the scheduling parameter on the basis of the derived scheduling parameter prediction model (step S5). In step S5, after calculating the value of the scheduling parameter, the scheduling parameter prediction model optimization unit 105 adjusts the calculated scheduling parameter so as to satisfy the condition that the condition that each value of the scheduling parameter is 0 or more and the sum of the values of the scheduling parameters of the m local models at the same time is 1.

Next, the optimality determination unit 106 determines whether the value of the evaluation function illustrated in formula (4) has converged (step S6). As described above, in step S4, the scheduling parameter prediction model optimization unit 105 calculates the value of the scheduling parameter when the value of the evaluation function illustrated in formula (4) becomes a minimum, with the calculated value of the state variable and the calculated value of the regression coefficient W⁽ⁱ⁾ as fixed values. For example, if an absolute value of a difference between the minimum value among the values of the evaluation function in the most recent step S4 and the minimum value among the values of the evaluation function in the previous step S4 is equal to or less than a predetermined threshold value, the optimality determination unit 106 may determine that the value of the evaluation function has converged. If the absolute value of the difference exceeds the predetermined threshold value, the optimality determination unit 106 may determine that the value of the evaluation function has not converged.

Alternatively, the optimality determination unit 106 calculates a Frobenius norm of a difference between the regression coefficient W⁽ⁱ⁾ calculated in the most recent step S3 and the regression coefficient W⁽ⁱ⁾ calculated in the previous step S3. Then, if the Frobenius norm is equal to or less than the predetermined threshold value, the optimality determination unit 106 may determine that the value of the evaluation function has converged. If the Frobenius norm exceeds the predetermined threshold value, the optimality determination unit 106 may determine that the value of the evaluation function has not converged. Note that it can be said that the Frobenius norm of the difference between the regression coefficients W⁽ⁱ⁾ expresses the proximity of the regression coefficients W⁽ⁱ⁾.

In the case where it is determined that the value of the evaluation function has not converged (No in step S6), the LPV model estimation system 100 repeats the processes from step S2 onward. In the processes of the second and subsequent steps S2, the state variable calculation unit 103 uses the value of the scheduling parameter calculated in the most recent step S5. Similarly, in the processes of the second and subsequent steps S3, the regression coefficient optimization unit 104 uses the value of the scheduling parameter calculated in the most recent step S5.

In the case where it is determined that the value of the evaluation function has converged (Yes in step S6), the system matrix optimization unit 107 optimizes each of the system matrices of the LPV model (A⁽ⁱ⁾, B⁽ⁱ⁾, K⁽ⁱ⁾, C, and D illustrated in formula (3)) using the value of the state variable obtained in the most recent step S2 and the value of the scheduling parameter (value adjusted so as to satisfy the above-described condition) obtained in the most recent step S5. The system matrix optimization unit 107 determines the LPV model that is expressed by using these system matrices A⁽ⁱ⁾, B⁽ⁱ⁾, K⁽ⁱ⁾, C, and D and the scheduling parameter prediction model obtained in the most recent step S4 (step S7). This LPV model is an estimation result of the LPV model of the target system.

Subsequently, the model estimation result output device 108 outputs the LPV model determined in step S7 (step S8).

In the present exemplary embodiment, the initialization unit 102 determines the initial value of the scheduling parameter. Thereafter, until it is determined that the value of the evaluation function illustrated in formula (4) converges, the state variable calculation unit 103 repeatedly calculates the value of the state variable the regression coefficient optimization unit 104 repeatedly calculates the regression coefficient, and the scheduling parameter prediction model optimization unit 105 repeatedly derives the scheduling parameter prediction model and calculates the scheduling parameter on the basis of the scheduling parameter prediction model. As a result, at a point in time when it is determined that the value of the evaluation function has converged, an optimum value of the state variable, an optimum scheduling parameter prediction model, and an optimum value of the scheduling parameter are obtained. Thereafter, the system matrix optimization unit 107 optimizes each system matrix A⁽ⁱ⁾, B⁽ⁱ⁾, K⁽ⁱ⁾, C, and D of the LPV model by using the optimum value of the state variable and the optimum value of the scheduling parameter, and determines the LPV model expressed by using each system matrix and the optimal scheduling parameter prediction model. Therefore, it is possible to the LPV model of the target system even if it is not possible to obtain the value of the scheduling parameter.

Furthermore, in the present exemplary embodiment, the scheduling parameter in the estimated LPV model is expressed by the scheduling parameter prediction model. That is, the scheduling parameter can be expressed using the explanatory variable in the LPV model of the target system. Therefore, there are obtained effects that the value of the scheduling parameter can be derived from the predicted value of the explanatory variable and the state of the target system in the future is easily controlled.

### Second Exemplary Embodiment

A LPV model estimation system according to a second exemplary embodiment does not use a scheduling parameter prediction model in a LPV model of a target system. In other words, the LPV model estimation system according to the second exemplary embodiment directly expresses the scheduling parameter itself, rather than expressing the scheduling parameter by an explanatory variable in the LPV model.

That is, in the second exemplary embodiment, the LPV model is expressed as formula (1).

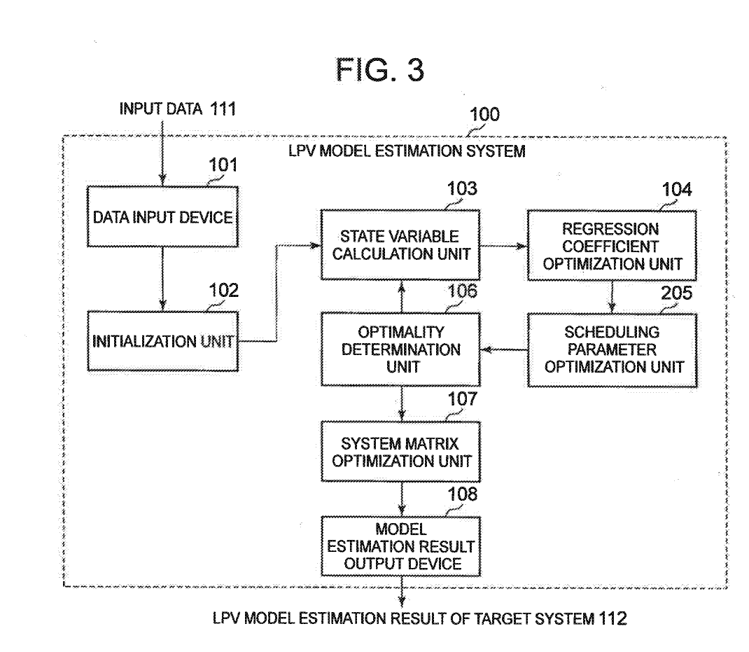

FIG. 3 is a block diagram illustrating an exemplary configuration of the LPV model estimation system according to the second exemplary embodiment of the present invention. Elements similar to those in the first exemplary embodiment are denoted by the same reference signs as those in FIG. 1, and description thereof is omitted. The LPV model estimation system 100 according to the second exemplary embodiment includes a data input device 101, an initialization unit 102, a state variable calculation unit 103, a regression coefficient optimization unit 104, a scheduling parameter optimization unit 205, an optimality determination unit 106, a system matrix optimization unit 107, and a model estimation result output device 108. The data input device 101, the initialization unit 102, the state variable calculation unit 103, the regression coefficient optimization unit 104, the optimality determination unit 106, the system matrix optimization unit 107, and the model estimation result output device 108 are similar to those elements in the first exemplary embodiment.

In the second exemplary embodiment, an input data 111 may not include information illustrating the format of the scheduling parameter prediction model and the value of an explanatory variable φ at past time. The other data included in the input data 111 is similar to that in the first exemplary embodiment.

The scheduling parameter optimization unit 205 optimizes the scheduling parameter of each local model, with the calculated value of the state variable and the calculated value of the regression coefficient W⁽ⁱ⁾ as fixed values. That is, the scheduling parameter optimization unit 205 calculates the value of the scheduling parameter when the value of the evaluation function of the LPV system identification (refer to formula (4)) becomes a minimum, with the calculated value of the state variable and the calculated value of the regression coefficient W⁽ⁱ⁾ as fixed values. Note that the scheduling parameter optimization unit 205 obtains the value of the scheduling parameter μₖ⁽ⁱ⁾ of each local model at time k=p, p+1, . . . , and N.

The operation of the scheduling parameter optimization unit 205 that the calculates the value of the scheduling parameter when the value of the evaluation function becomes a minimum, with the value of the state variable and the value of the regression coefficient W⁽ⁱ⁾ as fixed values is similar to the operation of the scheduling parameter prediction model optimization unit 105 according to the first exemplary embodiment that calculates the value of the scheduling parameter at the time of deriving the scheduling parameter prediction model.

Note that as in the first exemplary embodiment, the system matrix optimization unit 107 calculates each system matrix A⁽ⁱ⁾, B⁽ⁱ⁾, K⁽ⁱ⁾, C, and D (refer to formula (1)). Then, the system matrix optimization unit 107 determines the LPV model expressed as formula (1), using the A⁽ⁱ⁾B⁽ⁱ⁾, K⁽ⁱ⁾, C, and D and the scheduling parameter obtained at a point in time when it is determined that the value of the evaluation function converged. This LPV model is an estimation result of the LPV model of the target system.

The initialization unit 102, the state variable calculation unit 103, the regression coefficient optimization unit 104, the scheduling parameter optimization unit 205, the optimality determination unit 106, and the system matrix optimization unit 107 are achieved by, for example, a CPU in a computer that operates according to the linear parameter-varying model estimation program. In this case, the CPU reads a linear parameter-varying model estimation program from a program recording medium such as a program storage device (not illustrated in FIG. 3) of the computer, for example, and in accordance with the program, operates as the initialization unit 102, the state variable calculation unit 103, The regression coefficient optimization unit 104, the scheduling parameter optimization unit 205, the optimality determination unit 106, and the system matrix optimization unit 107. Furthermore, the initialization unit 102, the state variable calculation unit 103, the regression coefficient optimization unit 104, the scheduling parameter optimization unit 205, the optimality determination unit 106, and the system matrix optimization unit 107 are realized by separate hardware.

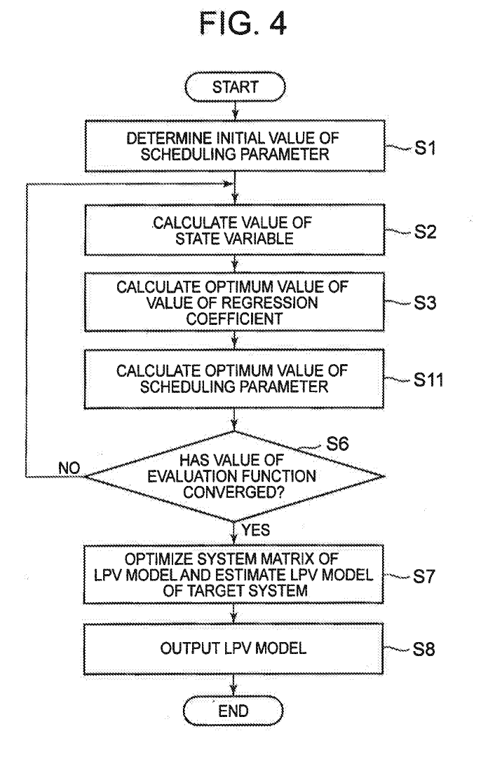

Next, a process progress according to the second exemplary embodiment will be described. FIG. 4 is a flowchart illustrating an exemplary process progress according to the second exemplary embodiment. Processes similar to those in the first exemplary embodiment are denoted by the same reference signs as those in FIG. 2. It is assumed that the data input device 101 has obtains the input data 111.

Steps S1 to S3 are similar to steps S1 to S3 in the first exemplary embodiment.

Following step S3, the scheduling parameter optimization unit 205 calculates the optimum value of the scheduling parameter of each local model, with the calculated value of the state variable and the calculated value of the regression coefficient W⁽ⁱ⁾ as fixed values (step S11). That is, the scheduling parameter optimization unit 205 calculates the value of the scheduling parameter when the value of the evaluation function illustrated in formula (4) becomes a minimum, with the calculated value of the state variable and the calculated value of the regression coefficient W⁽ⁱ⁾ as fixed value.

Next, the optimality determination unit 106 determines whether the value of the evaluation function illustrated in formula (4) has converged (step S6). For example, if an absolute value of a difference between the minimum value among the values of the evaluation function in the most recent step S11 and the minimum value among the values of the evaluation function in the previous step S11 is equal to or less than a predetermined threshold value, the optimality determination unit 106 may determine that the value of the evaluation function has converged and if the absolute value of the difference exceeds the predetermined threshold value, the optimality determination unit 106 may determine that the value of the evaluation function has not converged.

Alternatively, as described in the first exemplary embodiment, the optimality determination unit 106 calculates a Frobenius norm of a difference between the regression coefficient W⁽ⁱ⁾ calculated in the most recent step S3 and the regression coefficient W⁽ⁱ⁾ calculated in the previous step S3. Then, if the Frobenius norm is equal to or less than the predetermined threshold value, the optimality determination unit 106 may determine that the value of the evaluation function has converged. If the Frobenius norm exceeds the predetermined threshold value, the optimality determination unit 106 may determine that the value of the evaluation function has not converged.

In the case where it is determined that the value of the evaluation function has not converged (No in step S6), the LPV model estimation system 100 repeats the processes from step S2 onward. In the processes of the second and subsequent steps S2, the state variable calculation unit 103 uses the value of the scheduling parameter calculated in the most recent step S11. Similarly, in the processes in the second and subsequent steps S3, the regression coefficient optimization unit 104 uses the value of the scheduling parameter calculated in the most recent step S11.

In the case where it is determined that the value of the evaluation function has converged (Yes in step S6), the system matrix optimization unit 107 optimizes each system matrix of the LPV model (A⁽ⁱ⁾, B⁽ⁱ⁾, K⁽ⁱ⁾, C, and D illustrated in formula (1)) using the value of the state variable obtained in the most recent step S2 and the value of the scheduling parameter calculated in the most recent step S11. The system matrix optimization unit 107 determines the LPV model that is expressed by using these system matrices A⁽ⁱ⁾, B⁽ⁱ⁾, K⁽ⁱ⁾, C, and D and the value of the scheduling parameter calculated in the most recent step S11 (step S7). This LPV model is an estimation result of the LPV model of the target system.

Subsequently, the model estimation result output device 108 outputs the LPV model determined in step S7 (step S8).

In the present exemplary embodiment, the initialization unit 102 determines the initial value of the scheduling parameter. Thereafter, until it is determined that the value of the evaluation function illustrated in formula (4) converges, the state variable calculation unit 103 repeatedly calculates the state variable, the regression coefficient optimization unit 104 repeatedly calculates the regression coefficient, and the scheduling parameter optimization unit 205 repeatedly calculates the scheduling parameter. As a result, at a point in time when it is determined that the value of the evaluation function has converged, the optimum value of the state variable and the optimum value of the scheduling parameter are obtained. Thereafter, the system matrix optimization unit 107 optimizes each system matrix A⁽ⁱ⁾, B⁽ⁱ⁾, K⁽ⁱ⁾, C, and D of the LPV model using the optimum value of the state variable and the optimum value of the scheduling parameter, and determines the LPV model expressed using each system matrix and the optimum value of the scheduling parameter. Therefore, it is possible to the LPV model of the target system even if it is not possible to obtain the value of the scheduling parameter.

Furthermore, it is possible to determine whether an abnormality occurred in the target system in the past by using the obtained optimum value of the scheduling parameter. If the optimum value of the scheduling parameter does not satisfy a condition for achieving a convex combination of the local models (each initial value of the scheduling parameter is 0 or more, and the sum of the initial values of the scheduling parameters of the m local models at the same time is 1), it can be determined that an abnormality occurred in the target system at the time.

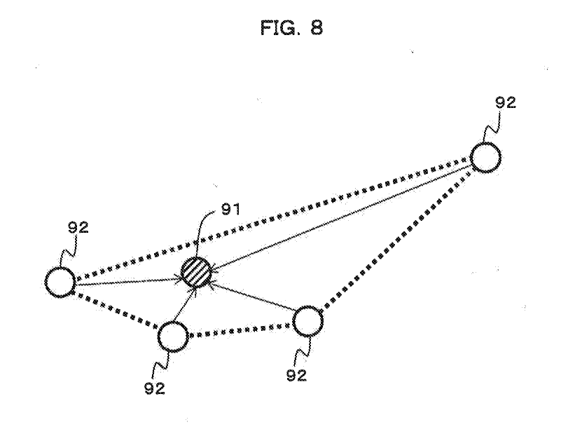

Furthermore, in the second exemplary embodiment, as illustrated in FIG. 8, a convex hull covering the operation region of an object to be controlled can be formed. Therefore, it is possible to execute stabilize secondary stabilization control (robust control).

Furthermore, in the first exemplary embodiment described above, since the scheduling parameter can be predicted, it is possible to perform the gain scheduling control in which the control gain of the local model is weighted by the scheduling parameter as the control gain of the LPV model. Compared with the secondary stabilization control described above, since this control also uses information on which point of the convex hull, higher control performance can be expected.

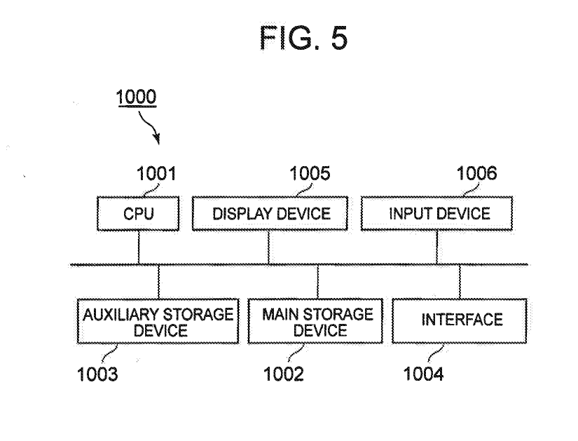

FIG. 5 is a schematic block diagram illustrating an exemplary configuration of a computer according to each exemplary embodiment of the present invention. A computer 1000 includes, for example, a CPU 1001, a main storage device 1002, an auxiliary storage device 1003, an interface 1004, a display device 1005, and an input device 1006. In the example illustrated in FIG. 5, the input device 1006 corresponds to the data input device 101 (refer to FIGS. 1 and 3), and the display device 1005 corresponds to the model estimation result output device 108 (refer to FIGS. 1 and 3). However, the computer 1000 includes the data input device 101 according to a mode in which the input data 111 is obtained and the model estimation result output device 108 corresponding to an output mode of the LPV model estimation result 112.

The LPV model estimation system 100 according to each exemplary embodiment is installed in the computer 1000. The operation of the LPV model estimation system 100 is stored in the auxiliary storage device 1003 in the form of a program (linear parameter-varying model estimation program). The CPU 1001 reads the program from the auxiliary storage device 1003, develops the program in the main storage device 1002, and executes the above-described process according to the program.

The auxiliary storage device 1003 is an example of a non-transitory tangible medium. Other examples of non-transitory tangible media include magnetic disks, magneto-optical disks, CD-ROMs, DVD-ROMs, semiconductor memories, and the like connected via the interface 1004. Furthermore, in the case where this program is delivered to the computer 1000 via a communication line, the computer 1000 that receives the distribution may develop the program in the main storage device 1002 and execute the above-described processes.

Furthermore, the program may be for achieving a part of the above-described processes. Furthermore, the program may be a differential program achieving the above-described process in combination with another program already stored in the auxiliary storage device 1003.

Furthermore, the constituent elements of the LPV model estimation system according to the first exemplary embodiment of the present invention (data input device 101, initialization unit 102, state variable calculation unit 103, regression coefficient optimization unit 104, scheduling parameter prediction model optimization unit 105, optimality determination unit 106, system matrix optimization unit 107, and model estimation result output device 108) may be each achieved by a circuitry. Similarly, each constituent element of the LPV model estimation system according to the second exemplary embodiment of the present invention (data input device 101, initialization unit 102, state variable calculation unit 103, regression coefficient optimization unit 104, scheduling parameter optimization unit 205, optimality determination unit 106, system matrix optimization unit 107, and model estimation result output device 108) may also be each achieved by a circuitry. Herein, the circuitry is a term conceptually including a single device, multiple devices, a chipset or cloud.

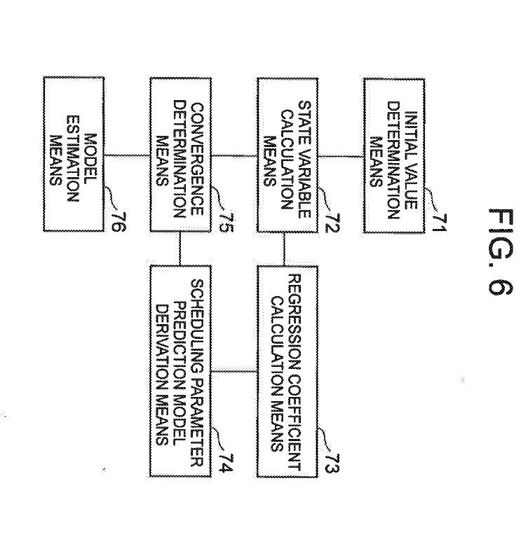

Next, an overview of the present invention will be described. FIG. 6 is a block diagram illustrating an overview of an LPV model estimation system according to the present invention. The LPV model estimation system includes an initial value determination means 71, a state variable calculation means 72, a regression coefficient calculation means 73, a scheduling parameter prediction model derivation means 74, a convergence determination means 75, and a model estimation means 76.

The initial value determination means 71 (for example, initialization unit 102) determines the initial value of the scheduling parameter of the target system to be modeled by the linear parameter-varying model.

The state variable calculation means 72 (for example, state variable calculation unit 103) calculates the value of the state variable on the basis of a value of input data, a value of output data, and a value of the scheduling parameter of the target system.

The regression coefficient calculation means 73 (for example, regression coefficient optimization unit 104) calculates the value of the regression coefficient when the value of the predetermined evaluation function (for example, evaluation function illustrated in formula (4)) becomes a minimum, with the value of the scheduling parameter and the value of the state variable as fixed values.

The scheduling parameter prediction model derivation means 74 (for example, scheduling parameter prediction model optimization unit 105) calculates the value of the scheduling parameter when the value of the predetermined evaluation function becomes a minimum, with the value of the state variable and the value of the regression coefficient as fixed values, derives a scheduling parameter prediction model that is a function of the scheduling parameter using the explanatory variable, on the basis of the value of the scheduling parameter and a previously given value of the explanatory variable, and calculate the value of the scheduling parameter on the basis of the scheduling parameter prediction model.

The convergence determination means 75 (for example, optimality determination unit 106) determines whether the value of the evaluation function has converged.

With respect to the state variable calculation means 72, the regression coefficient calculation means 73, and the scheduling parameter prediction model derivation means 74, until it is determined that that the value of the evaluation function has converged, the state variable calculation means 72 repeatedly calculates the value of the state variable, the regression coefficient calculation means 73 repeatedly calculates the value of the regression coefficient, and the scheduling parameter prediction model derivation means 74 repeatedly derives the scheduling parameter prediction model and calculates the value of the scheduling parameter on the basis of the scheduling parameter prediction model.

The model estimation means 76 (for example, system matrix optimization unit 107) estimates the linear parameter-varying model of the target system on the basis of the value of the state variable and the value of the scheduling parameter at a point in time when it is determined that the value of the evaluation function has converged. At this time, the model estimation means 76 expresses the scheduling parameter by the scheduling parameter prediction model in the linear parameter-varying model.

With such a configuration, it is possible to estimate the LPV model of the target system and express the scheduling parameter using the explanatory variable in the LPV model of the target system even if it is not possible to grasp the value of the scheduling parameter,

Furthermore, it is preferable that the scheduling parameter prediction model derivation means 74 adjusts the value of the scheduling parameter calculated on the basis of the scheduling parameter prediction model such that each value of the scheduling parameter is 0 or more and the sum of the values of the scheduling parameters at the same time is 1.

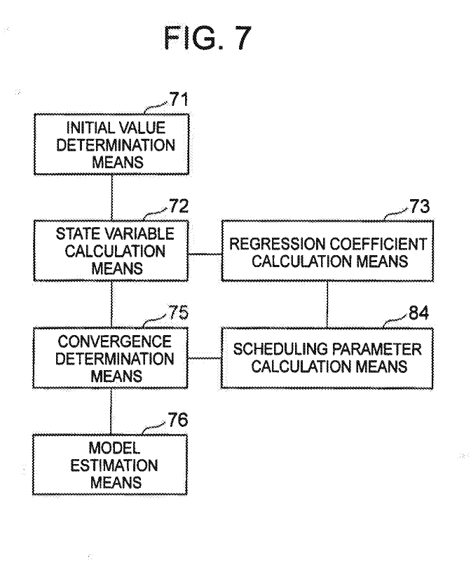

FIG. 7 is a block diagram illustrating an overview of an LPV model estimation system according to another embodiment of the present invention. The LPV model estimation system includes an initial value determination means 71, a state variable calculation means 72, a regression coefficient calculation means 73, a scheduling parameter calculation means 84, a convergence determination means 75, and a model estimation means 76.

The initial value determination means 71, the state variable calculation means 72 and the regression coefficient calculation means 73 illustrated in FIG. 7 are similar to the initial value determination means 71, the state variable calculation means 72 and the regression coefficient calculation means 73 illustrated in FIG. 6, respectively.

The scheduling parameter calculation means 84 (for example, scheduling parameter optimization unit 205) calculates the value of the scheduling parameter when the value of the predetermined evaluation function (for example, evaluation function illustrated in formula (4)) becomes a minimum, with the value of the state variable and the value of the regression coefficient as fixed values.

The convergence determination means 75 (for example, optimality determination unit 106) determines whether the value of the evaluation function has converged.

With respect to the state variable calculation means 72, the regression coefficient calculation means 73, and the scheduling parameter calculation means 84, until it is determined that the value of the evaluation function has converged, the state variable calculation means 72 repeatedly calculates the value of the state variable, the regression coefficient calculation means 73 repeatedly calculates the value of the regression coefficient, and the scheduling parameter calculation means 84 repeatedly calculates the value of the scheduling parameter.

The model estimation means 76 (for example, system matrix optimization unit 107) estimates the linear parameter-varying model of the target system on the basis of the value of the state variable and the value of the scheduling parameter at a point in time when it is determined that the value of the evaluation function has converged.

With such a configuration, it is possible to estimate the LPV model of the target system even if it is not possible to grasp the value of the scheduling parameter.

Furthermore, in the configurations illustrated in FIGS. 6 and 7, it is preferable that the initial value determination means 71 determines the initial value of the scheduling parameter such that each value of the scheduling parameter is 0 or more and the sum of the initial values of the scheduling parameters at the same time is 1.

Although the present invention has been described above with reference to the exemplary embodiments, the present invention is not limited to the above exemplary embodiments. Various changes that can be understood by those skilled in the art in the scope of the present invention can be made to the configurations and details of the present invention.

This application claims priority on the basis of U.S. Provisional Application No. 62/169,796, filed on Jun. 2, 2015.

### INDUSTRIAL APPLICABILITY

The present invention is suitably applied to an LPV model estimation system for estimating an LPV model of a physical system.

### REFERENCE SIGNS LIST

100 LPV model estimation system (Linear parameter-varying model estimation system)
101 Data input device
102 Initialization unit
103 State variable calculation unit
104 Regression coefficient optimization unit
105 Scheduling parameter prediction model optimization unit
106 Optimality determination unit
107 System matrix optimization unit
108 Model estimation result output device
205 Scheduling parameter optimization unit

1. A linear parameter-varying model estimation system, comprising:
an initial value determination unit, implemented by a processor, for determining an initial value of a scheduling parameter of a target system to be modeled by a linear parameter-varying model;
a state variable calculation unit, implemented by a processor, for calculating a value of a state variable on the basis of a value of input data, a value of output data, and a value of a scheduling parameter of the target system;
a regression coefficient calculation unit, implemented by a processor, for calculating a value of a regression coefficient when a value of a predetermined evaluation function becomes a minimum, with the value of the scheduling parameter and the value of the state variable as fixed values;
a scheduling parameter prediction model derivation unit, implemented by a processor, for calculating the value of the scheduling parameter when the value of the predetermined evaluation function becomes a minimum, with the value of the state variable and the value of the regression coefficient as fixed values, the scheduling parameter prediction model derivation unit deriving a scheduling parameter prediction model that is a function of the scheduling parameter using an explanatory variable on the basis of the value of the scheduling parameter and a previously given value of the explanatory variable, and calculating the value of the scheduling parameter on the basis of the scheduling parameter prediction model; and
a convergence determination unit, implemented by the processor, for determining whether the value of the evaluation function has converged,
wherein with respect to the state variable calculation unit, the regression coefficient calculation unit, and the scheduling parameter prediction model derivation unit, until it is determined that the value of the evaluation function has converged, the state variable calculation unit repeatedly calculates the value of the state variable, the regression coefficient calculation unit repeatedly calculates the value of the regression coefficient, the scheduling parameter prediction model derivation unit repeatedly derives the scheduling parameter prediction model and calculating the value of the scheduling parameter on the basis of the scheduling parameter prediction model;
the linear parameter-varying model estimation system further comprises a model estimation unit, implemented by the processor, for estimating the linear parameter-varying model of the target system on the basis of the value of the state variable and the value of the scheduling parameter at a point in time when it is determined that the value of the evaluation function has converged; and
the model estimation unit expresses the scheduling parameter by the scheduling parameter prediction model in the linear parameter-varying model.

2. The linear parameter-varying model estimation system according to claim 1,
wherein the scheduling parameter prediction model derivation unit adjusts the value of the scheduling parameter calculated on the basis of the scheduling parameter prediction model such that each value of the scheduling parameter is 0 or more and the sum of the values of the scheduling parameters at the same time is 1.

3. A linear parameter-varying model estimation system, comprising:
an initial value determination unit, implemented by a processor, for determining an initial value of a scheduling parameter of a target system to be modeled by a linear parameter-varying model;
a state variable calculation unit, implemented by the processor, for calculating a value of a state variable on the basis of a value of input data, a value of output data, and a value of a scheduling parameter of the target system;
a regression coefficient calculation unit, implemented by the processor, for calculating a value of a regression coefficient when a value of a predetermined evaluation function becomes a minimum, with the value of the scheduling parameter and the value of the state variable as fixed values;
a scheduling parameter calculation unit, implemented by the processor, for calculating a value of the scheduling parameter when the value of the predetermined evaluation function becomes a minimum, with the value of the state variable and the value of the regression coefficient as fixed values; and
a convergence determination unit, implemented by the processor, for determining whether the value of the evaluation function has converged,
wherein with respect to the state variable calculation unit, the regression coefficient calculation unit, and the scheduling parameter calculation unit,
until it is determined that the value of the evaluation function has converged, the state variable calculation unit repeatedly calculates the value of the state variable, the regression coefficient calculation unit repeatedly calculates the value of the regression coefficient, and the scheduling parameter calculation unit repeatedly calculates the value of the scheduling parameter; and
the linear parameter-varying model estimation system further comprises a model estimation unit, implemented by the processor, for estimating the linear parameter-varying model of the target system on the basis of the value of the state variable and the value of the scheduling parameter at a point in time when it is determined that the value of the evaluation function has converged.

4. The linear parameter-varying model estimation system according to claim 1,
wherein the initial value determination unit determines the initial value of the scheduling parameter such that each value of the scheduling parameter is 0 or more and the sum of the initial values of the scheduling parameter at the same time is 1.

5. A linear parameter-varying model estimation method, comprising:
determining an initial value of a scheduling parameter of a target system to be modeled by a linear parameter-varying model;
calculating a value of a state variable on the basis of a value of input data, a value of output data, and a value of a scheduling parameter of the target system;
calculating a value of a regression coefficient when a value of a predetermined evaluation function becomes a minimum, with the value of the scheduling parameter and the value of the state variable as fixed values;
calculating a value of the scheduling parameter when the value of the predetermined evaluation function becomes a minimum, with the value of the state variable and the value of the regression coefficient as fixed values, deriving a scheduling parameter prediction model that is a function of the scheduling parameter using an explanatory variable on the basis of the value of the scheduling parameter and a previously given value of the explanatory variable, and calculating the value of the scheduling parameter on the basis of the scheduling parameter prediction model;
determining whether the value of the evaluation function has converged;
until it is determined that the value of the evaluation function has converged, repeatedly calculating the value of the state variable, calculating the value of the regression coefficient, deriving a scheduling parameter prediction model, and calculating the value of the scheduling parameter on the basis of the scheduling parameter prediction model; and
estimating the linear parameter-varying model of the target system on the basis of the value of the state variable and the value of the scheduling parameter at a point in time when it is determined that the value of the evaluation function has converged and expressing the scheduling parameter by the scheduling parameter prediction model in the linear parameter-varying model.

6. The linear parameter-varying model estimation method according to claim 5,
wherein the value of the scheduling parameter calculated on the basis of the scheduling parameter prediction model is adjusted such that each value of the scheduling parameter is 0 or more and the sum of the values of the scheduling parameters at the same time is 1.

7.-10. (canceled)
